(19) United States
(12) Patent Application Publication
(10) Pub. No.: US 2006/0220383 A1
(43) Pub. Date: Oct. 5, 2006

(54) STEAMOUT EFFLUENT CATCHMENT BLIND FOR TANKS AND PRESSURE TANKS

(76) Inventor: Brian Erickson, Drayton Valley, AB (CA)

Correspondence Address: SANDER R. GEISING, 600, 4911-51 STREET, RED DEER, AB, T4N-6V4, CA

(21) Appl. No.: 11/277,997

(22) Filed: Mar. 30, 2006

Related U.S. Application Data
(60) Provisional application No. 60/668,582, filed on Apr. 6, 2005.

(30) Foreign Application Priority Data
Mar. 30, 2005 (CA) 2502823

(51) Int. Cl. F16L 23/00

(52) U.S. Cl. 285/405; 285/363; 285/120.1

(57) ABSTRACT

An apparatus for redirecting fluid at a flanged connection is disclosed. The apparatus comprises a flattened section and a tubular section. The flattened section is suitable for insertion between two adjacent flanges of the flanged connection and the tubular section is suitable for attachment to a conduit such as a hose or pipe. The flattened section has a front face, a rear face and an inlet on the front face. The tubular section has an outlet and the interior of the flattened section is in fluid communication with the interior of the tubular section. The flattened section is sufficiently thin to allow the flanged connection to be reassembled, with the apparatus installed, without redesign or dismantling of any related piping.

### CROSS REFERENCE TO RELATED APPLICATION

This application is a regular application of U.S. Provisional Patent Application Ser. No. 60/668,582 filed Apr. 6, 2005 and entitled, “STEAMOUT EFFLUENT CATCHMENT BLIND FOR TANKS AND PRESSURE TANKS”, the entirety of which is incorporated herein by reference.

### FIELD OF THE INVENTION

This invention relates generally to catchment devices and clean-out blinds and, more particularly, to devices for installation or insertion between flanges or flanged sections of pipe to facilitate catching and redirecting steam and water effluent.

### BACKGROUND OF THE INVENTION

During clean-up times or turn-arounds at refineries, petrochemical and other oil-and-gas facilities, when typically dozens of pressure vessels in a plant are purged and cleaned with steam, clean-up crews often unbolt flanged sections of piping to provide an exit for the steam and water that has gone through a pressure vessel and piping as part of the clean-out process. It is not uncommon for the clean-up crews to simply let the steam escape into the atmosphere and allow the water run onto the ground or floor.

One problem with this is that the steam vapour and water effluent will be contaminated with whatever was inside the pressure vessel or piping. Contaminants may include hydrocarbons, H₂S or carcinogenic substances; and would thus be released to the surroundings, creating environmental and safety concerns.

A further problem is that the piping between the various pressure vessels is often fixed in place. It is therefore difficult to remove a section of pipe to attach a vacuum hose or other containment means. It is simply easier to unbolt flanged sections of pipe, and perhaps slide one relative to another, thereby creating an opening for the steam and water to exit. This has worked because all that typically exits during a clean-out of a plant or pressure vessel is the contaminated steam and water, requiring only a relatively small opening or crack.

Applicant is not aware of any device, suitable for catching and redirecting steam and water effluent during clean-outs and turn-arounds at refineries, petrochemical and other oil-and-gas facilities that is simple to operate, and can be easily and inexpensively manufactured and is installed between flanges in a straightforward manner.

### SUMMARY OF THE INVENTION

The invention provides an apparatus for redirecting fluid at a flanged connection. In one aspect the apparatus comprises a flattened or narrowed section suitable for insertion between two adjacent flanges of the flanged connection, said flattened section having a front face, a rear face and an inlet on the front face. The apparatus further comprises a tubular section suitable for attachment to a conduit, said tubular section having an outlet. The interior of the flattened section is in communication with the interior of the tubular section enabling effluent, which enters the intlet, to move from the flattened section to the tubular section and out the outlet.

In another embodiment, the flattened section further comprises a circumferential rim and a basin, the rim overlaying some of the outside circumference area of the basin so as to form circumferential channel along the periphery of the basin. The circumferential channel is in communication with the interior of the tubular section. A method aspect is also provided.

Advantages of the present invention include:
easy insertion and mounting of the device between flanged sections of pipe;
facilitating easy capture and containment of noxious vapours and contaminated effluent that would otherwise be released to atmosphere, ground or surrounding environment; and
ability, via a hose or pipe, to be hooked up to containment means or waste tank at atmospheric pressure, or to vacuum system (such as a vacuum truck).

### BRIEF DESCRIPTION OF THE DRAWINGS

FIGS. 1a-1c are various views of one embodiment of the present invention;

FIG. 2 is a front view of the embodiment of FIGS. 1a-1c shown adjacent a flanged section of pipe;

FIGS. 3a-3g are various perspective views of a second embodiment the present invention, without flutes or ridges in the basin;

FIGS. 4a-4d are various perspective views of the embodiment of FIGS. 1a-1c; and

FIG. 5 is a schematic side view of the embodiment of FIGS. 1a-1c shown installed between two flanged sections of pipe.

### DETAILED DESCRIPTION OF THE PREFERRED EMBODIMENTS

Reference is to be had to the Figures in which identical reference numbers identify similar components.

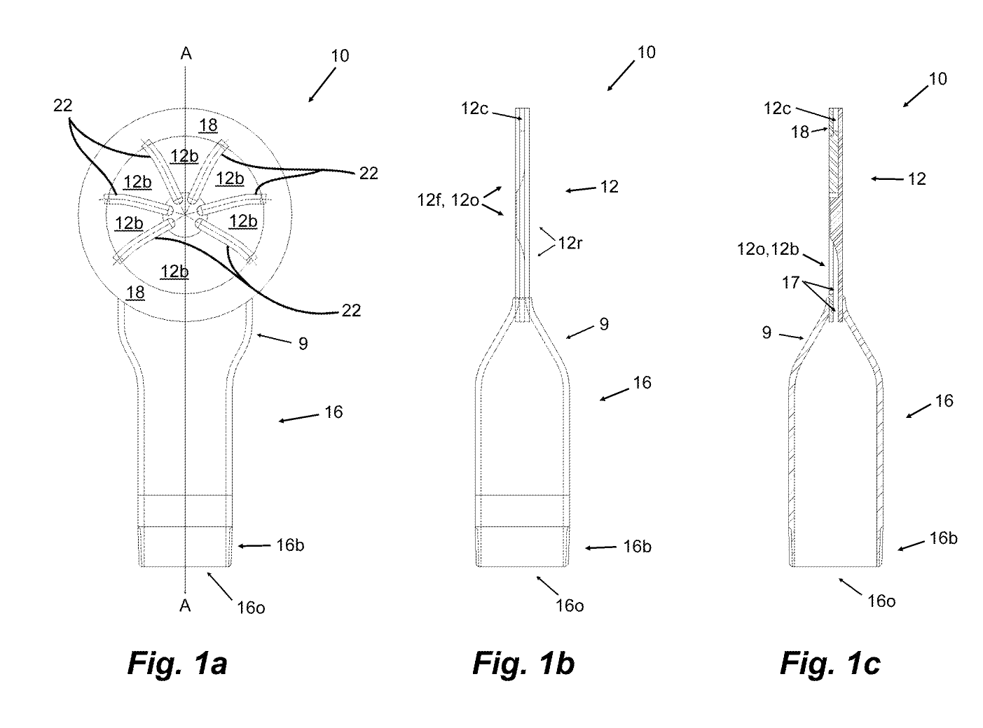

FIGS. 1a-1c, 2, 4a-4d and 5 show a first embodiment of an apparatus 10 for capturing and redirecting noxious vapours and contaminated effluent 11 that may be released during a clean-out of a pressure vessel (not shown) and associated piping 15, and which is easily installed or inserted at a flanged connection 20, such as between two flanges 14a, 14b or flanged sections of pipe 15.

The apparatus 10 comprises a flattened section or body member 12 connected to, and in communication with, a generally hollow tubular section or body member 16. The flattened section 12 is adapted for insertion and mounting between two adjacent flanges 14a, 14b of a pipeline 15 or between two adjacent flanges of other equipment such as pressure vessels (not shown). Preferably, the flattened section 12 connects to the tubular section 16 via a hollow neck portion 9. More preferably, the neck portion 9 gradually changes from a flattened profile (adjacent the flattened section 12) to a tubular profile (adjacent the tubular portion 16).

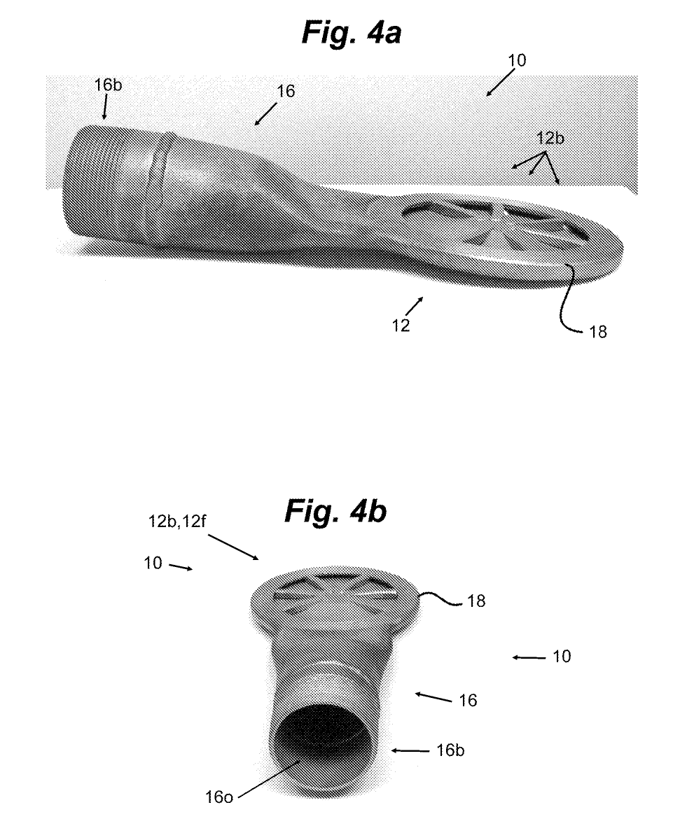

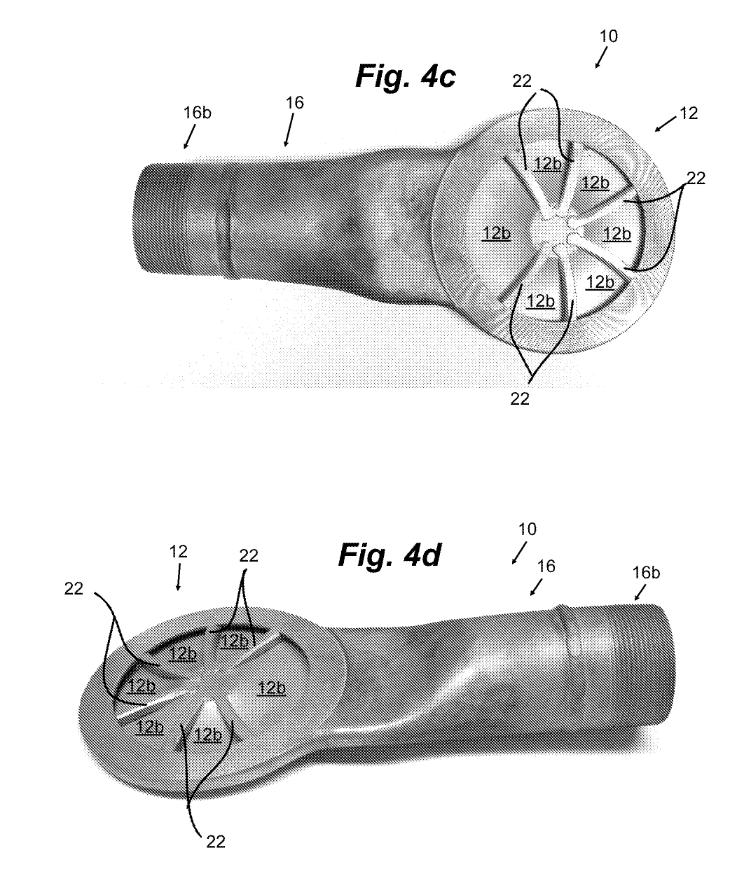

The flattened section 12 further comprises a front face 12f, a rear face 12r, an inlet or opening 12o on the front face 12f, a circumferential rim 18 and a basin or chamber 12b. The opening 12o is generally formed by the inner circumference of the rim 18. Likewise, the basin 12b is generally formed by the rear face 12r and the circumferential rim 18. The basin 12b is in fluid communication with the tubular section 16 through an opening or passage 17 in the rim 18. Preferably the rim 18 overlaps or overlays some of the outside circumference of the basin 12b so as to form a circumferential channel or passage 12c thereunder and along the periphery of the basin 12b. More preferably, the circumferential channel 12c is in fluid communication with the tubular section 16 through the opening or passage 17. Even more preferably, the basin portion 12b is convex shaped and has a plurality of ridges or flutes 22 (as shown more clearly in FIGS. 1a and 4a-4d) to facilitate the re-direction of steam and effluent 11 into circumferential passage 12c and subsequently into the tubular section 16 via passage 17.

The tubular section 16 is adapted for attachment or connection to a conduit 19, such as a hose or pipe, and further comprises an outlet or opening 16o. The conduit 19 is preferably used to connect the apparatus 10 to a containment tank at atmospheric pressure (not shown), a vacuum source such as a vacuum truck (also not shown) or other containment means for the effluent 11. More preferably, the end 16b of the tubular section 16 is threaded to facilitate attachment to the conduit 19.

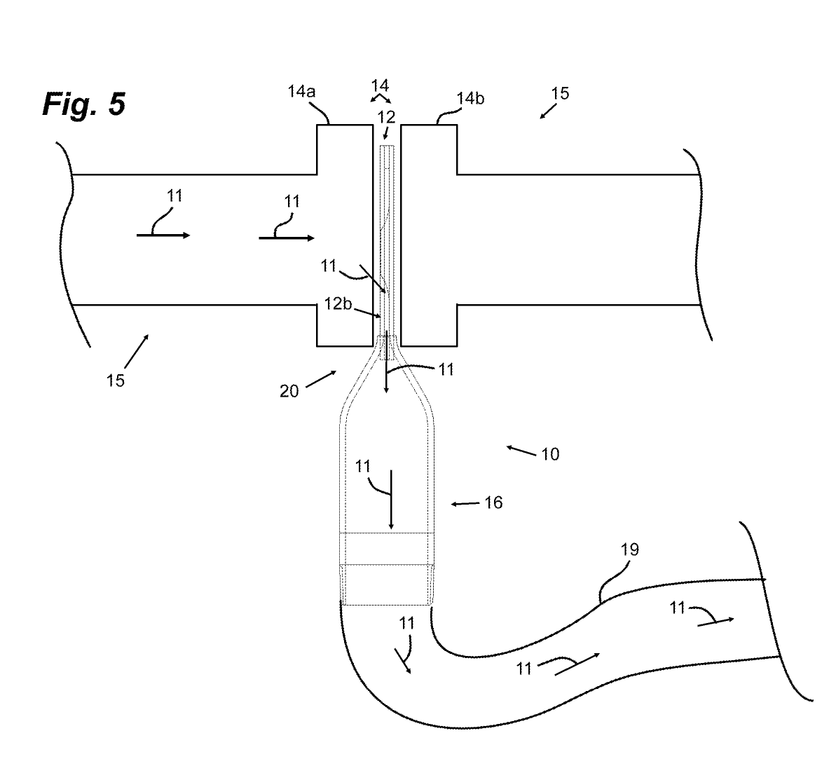

The flattened section 12 is of such planar dimensions so as to block the internal passage or channel of the pipeline 15 and to direct substantially all of the fluid or effluent flow 11 into the basin 12b when the flattened section 12 is inserted into the line 15 and mounted or supported at the flanged connection 20 (see FIG. 5). In this embodiment the flattened section 12 is generally circular, but it need not be as long as the section 12 is of sufficient planar dimensions so as to block the internal passage or channel of the pipeline 15 and direct substantially all of the fluid or effluent flow 11 into the basin 12b when the flattened section 12 is inserted into the line 15 and mounted or supported at the flanged connection 20.

The circumferential rim 18 is of such dimensions so as to facilitate sealing engagement of the apparatus 10 with the flange 14. Preferably the rim 18 is generally circular and of such dimensions so as to match the outside circumference and general wall thickness of the pipe 15. Advantageously, by matching the outside dimensions of the flattened section 12, and rim 18, to the outside dimensions of the pipeline 15, any bolts 23 that normally extend through the flanges 14a, 14b can still be used to reconnect and secure the flanges 14a, 14b after the apparatus 10 is inserted at the flanged connection 20.

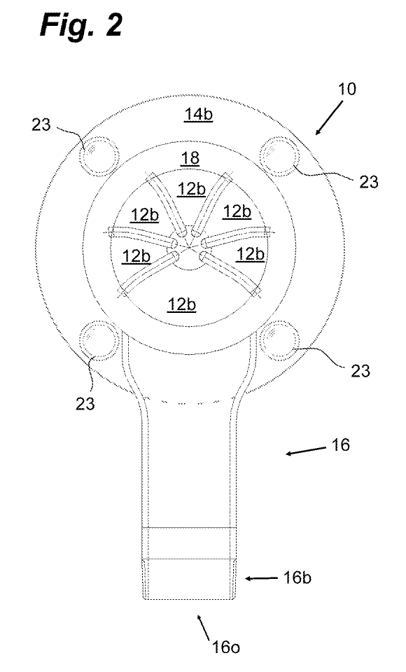

Preferably, the neck 9 is of such width and profile so as to allow the apparatus 10 to be inserted at the flanged connection 20 while at the same time allowing for the bolts 23 (that normally pass through the flanges 14a, 14b) to continue to pass through the flanges 14a, 14b and allow for the flanged connection 20 to be secured or connected in the normal fashion with the apparatus 10 inserted between the flanges 14a, 14b; see FIG. 2 for an illustration of one possible arrangement for positioning of the bolts 23 and neck 9. It will be appreciated by those skilled in the art, that other bolt placements or positioning, and neck 9 dimensions, will also work to keep the flanged connection 20 secured in the normal fashion when the apparatus 10 is inserted between the flanges 14a, 14b.

In another embodiment (not shown), the flattened section 12 is of an outside dimension so as to extend past the outside circumference of the pipe 15. In this embodiment holes, openings or recesses are provided through the flattened section 12 as needed so as to allow passage of the bolts therethrough and thereby allowing for the flanged connection 20 to be secured or connected in the normal fashion with the apparatus 10 inserted between the flanges 14a, 14b.

The apparatus 10, is preferably made from steel, but can also be made from other suitable material, such as a metal alloy or plastic.

Operation:

In operation, the flattened section 12 of the apparatus 10 is inserted at a flanged connection 20 between two flanges 14a, 14b, with the front face 12f and opening 12o positioned so as to catch and re-direct steam and effluent 11 from the pipeline 15, to the basin 12b and subsequently into the tubular section 16 via the opening or passage 17 (see FIG. 5). A sealing engagement, between the rim 18 and the flange 14 is then created by the user. Preferably the sealing engagement, between the rim 18 and flange 14, is created by reconnecting or re-bolting the two flanges 14a, 14b back together. Typical American Petroleum Institute flanges 14a, 14b are suitable.

The apparatus 10 can be inserted at a flanged connection 20 by disconnecting or unbolting the flanges 14a, 14b from each other and then either: displacing one flange 14a relative to the other 14b, laterally or axially, or temporarily removing one flange 14b and associated section of pipeline 15.

Preferably, a gasket (not shown) is positioned between the rim 18 and the flange 14, so as to further facilitate sealing engagement of the apparatus 10 to the flange 14. Advantageously, using a gasket enables the apparatus 10 work efficiently even if the steam or effluent 11 is under a high pressure.

Advantageously, by mounting or supporting the apparatus 10 from the flattened section 12, the apparatus 10 can be inserted at a flanged connection 20 without having to modify the structure of an existing pipeline 15; as the flattened section 12 and any additional gaskets are sufficiently thin to allow the flanged connection 20 to be reassembled without redesign or dismantling of the related piping.

In another aspect, the apparatus 10 may be used in the reverse, so as to direct fluid or gasses from the tubular section 16, to the flattened section 12 and into a flanged section of pipeline 15.

### Other Embodiments

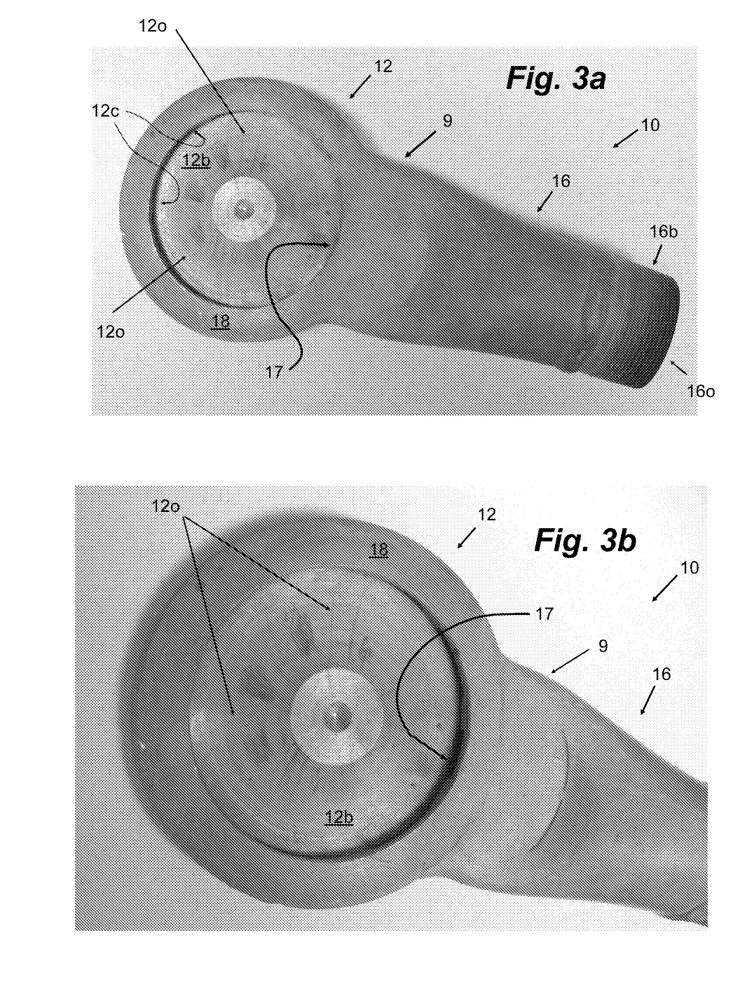

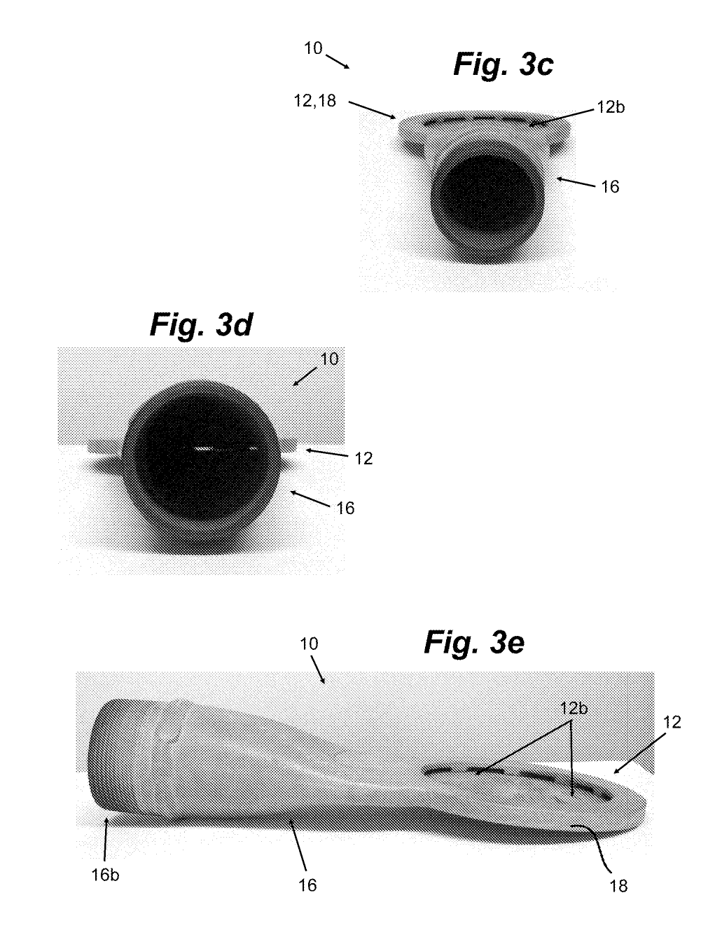

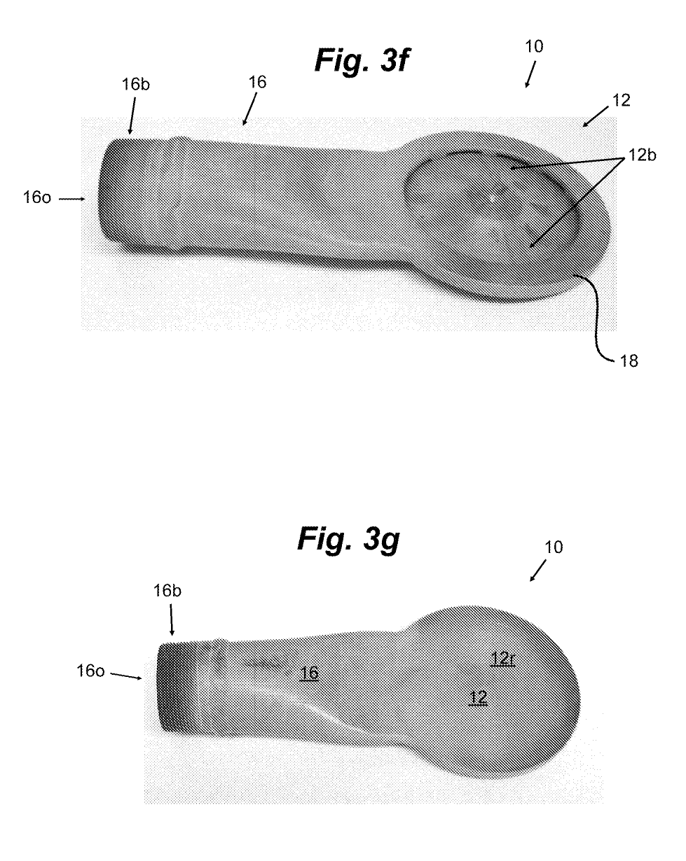

FIGS. 3a-3g illustrate another embodiment of the apparatus 10 without flutes in the basin 12b.

In yet another embodiment (not shown), there are a plurality of tubular sections 16 connected to the flattened section 12, each with their own passage 17.

The specific embodiments described should be taken as illustrative of the invention only and not as limiting its scope. Many further modifications and changes will readily occur to those skilled in the art to which the invention relates and the inventions should be construed in accordance with the accompanying claims.

1. An apparatus for redirecting fluid at a flanged connection, the apparatus comprising:
a flattened section suitable for insertion between two adjacent flanges of the flanged connection, said flattened section having a front face, a rear face and an inlet on the front face;
a tubular section suitable for attachment to a conduit, said tubular section having an outlet;
wherein the interior of the flattened section is in communication with the interior of the tubular section.

2. The apparatus of claim 1 wherein the flattened section further comprises a circumferential rim and a basin.

3. The apparatus of claim 2 wherein the rim overlays the outside circumference of the basin so as to form circumferential channel along the periphery of the basin, said circumferential channel being in communication with the interior of the tubular section.

4. The apparatus of claim 3 wherein the flattened section further comprises a plurality of ridges in the basin.

5. The apparatus of claim 4 wherein the tubular section further comprises a threaded end to facilitate attachment to said conduit.

6. The apparatus of claim 5 further comprising a neck portion between the flattened section and the tubular section, said neck portion gradually changing from a flattened profile adjacent said flattened section, to a tubular profile adjacent the tubular portion.

7. A method for redirecting fluid at a flanged connection, said flanged connection having two adjacent flanges, the method comprising the steps of:
providing an apparatus having a flattened section suitable for insertion between the two adjacent flanges of the flanged connection, said flattened section having an inlet on the front face, and also having a tubular section suitable for attachment to a conduit, said tubular section having an outlet, wherein the interior of the flattened section is in communication with the interior of the tubular section;
inserting said apparatus in the flanged connection with the front face and opening positioned so as to catch and re-direct said fluid; and
creating a sealing engagement between the apparatus and the flanged connection so that fluid will flow from the flanged connection, via the inlet, to the outlet.

8. The method of claim 7 wherein the step of creating a sealing engagement between the apparatus and the flanged connection further comprises bolting the two flanges together.

9. The method of claim 8 wherein the step of creating a sealing engagement between the apparatus and the flanged connection further comprises providing a gasket between the front face and one of the flanges of the flanged connection.

10. The method of claim 9 further comprising the step of connecting a conduit to the tubular section so as to enable fluid flowing out from the outlet to be directed into the conduit.
